(19) United States
(12) Patent Application Publication
(10) Pub. No.: US 2003/0139956 A1
(43) Pub. Date: Jul. 24, 2003

(54) Methods and systems for role analysis

(75) Inventors: Daniel Guenther, Morrison, CO (US); Janet Anderson, Westminster, CO (US)

Correspondence Address: Finnegan, Henderson, Farabow,, Garrett & Dunner, L.L.P., 1300 I Street, N.W., Washington, DC, 20005-3315, US

(73) Assignee: Sun Microsystems, Inc.

(21) Appl. No.: 10/225,230

(22) Filed: Aug. 22, 2002

Related U.S. Application Data
(63) Continuation-in-part of application No. 10/053,623, filed on Jan. 24, 2002.

(51) Int. Cl. G06F 17/60

(52) U.S. Cl. 705/7

(57) ABSTRACT

Methods, systems, and articles of manufacture of the present invention may involve a database for facilitating solution development or training. The database may comprise a scenario entity associated with at least one critical event, at least one of a work scope entity and a process entity associated with the scenario entity, and a core task entity associated with the at least one of the work scope entity and the process entity. The core task entity may correspond to at least one core task that facilitates solution development for the at least one critical event.

### RELATED APPLICATIONS

This application is a continuation-in-part of U.S. patent application Ser. No. 10/053,623, filed on Jan. 24, 2002, the entirety of which is incorporated herein by reference.

### BACKGROUND

1. Technical Field

The present invention generally relates to role analysis and/or data processing systems for performing role analysis. More particularly, methods and systems consistent with the present invention relate to analysis of roles, such as job requirements, the determination of skill gaps, and training needs of personnel within an organization.

2. Related Art

Many industries, such as the Information Technology (“IT”) industry, are swiftly evolving fields with rapidly changing needs and demands. In recent times, the booming IT industry has created new business requirements and technical needs for companies and organizations that change very quickly. To run efficiently, a company must employ well-trained IT professionals who are prepared to weather these changes and to handle unexpected events without negatively effecting the company or organization. Examples of such events may be migrating to a new business application, installing new or different hardware, moving from an Internet Service Provider (“ISP”) to an Application Service Provider (“ASP”), etc.

In ensuring that personnel are adequately trained and prepared, IT companies in particular need to determine what needs to be done, identify who is supposed to be doing it, and determine if they are able to do it. They also need to determine what skill gaps there are in their organization and determine what training would fill these gaps. In addition, they need to know what training has been given or, what is already known, to avoid redundant training.

Many IT organizations are growing so fast that roles and functions are both undefined and often unclear. Many employees do not know the specific functions of their jobs and do not know the aspects of their jobs for which they would need training. Businesses also change focus, for example, moving from being an ISP to an ASP. Such a change in focus often involves changes in both processes and functions among personnel making individual roles become even more unclear. Also, many IT managers do not have a sufficient level of experience to understand the difference in technical roles required among such functional areas as fault management, configuration management, security management, etc.

Additionally, traditional job descriptions may not accurately reflect the work that the IT professional is required to perform due to the need for versatility. For example, an organization might deploy a new level of technology, move from an ISP to an ASP, or acquire an enterprise-level server. Several people may then find themselves with new duties due to that technical acquisition or change. The new acquisition of duties results in “ad hoc” work, some of which may be temporary, and some of which may evolve into a permanent part of the person's job description. Small or mid-size organizations often find themselves without the appropriate resources identified to support new technical acquisitions. Accordingly, a need arises for correctly and efficiently analyzing jobs to be performed and their requirements.

A report by the Gartner Group, G. Raphaelian, “Trends in IT Job Definitions,” October 1996, which is incorporated herein by reference, goes further to describe emerging trends in the area of roles for employees in IT organizations. Specifically, when traditional job descriptions are too narrow, work roles afford the enterprise greater flexibility in defining responsibilities without casting the employee as one specific type of worker or another. Several other documents also describe concepts related to roles for employees including Cascio, “Applied Psychology in Personnel Management” (Prentice Hall, 1978, Chapters 4 and 10), Nadler et al., “Organization Architecture: Designs for Changing Organizations” (Jossey-Bass, 1992, Chapters 2 and 5), and Robinson & Robinson, “Performance Consulting: Moving Beyond Training” (Berrett-Koehler Publisher, Inc., 1995, Chapter 7), which are incorporated herein by reference.

Additionally, IT employees are constantly acquiring new knowledge on different platforms and tool sets as an organization's technology changes. This high level knowledge of acquisition drives massive change in roles and the tasks performed, and may further impact traditional job descriptions that are not fluid enough to accurately reflect an individual's work. The massive and rapid changes occurring in the IT business create a desire for the analysis of personnel, jobs, requirements, and training.

Job roles vary worldwide with respect to responsibilities, even within similar job titles. This variance is due to a number of factors having to do with levels of technology, available resources, and organizational size. To take one example, a network engineer in a small company may perform a greater variety of tasks and have different responsibilities as compared to a network engineer in a large company. In large companies, for example, network engineers may focus more on specific tasks. In smaller companies, a network engineer may have to be more of a generalist. For example, in a small company, the network engineer may be responsible for tasks ranging from recovery, back-up, incident management, security management, as well as the standard tasks associated with the network engineer job title, such as network implementation, configuring and resolving network equipment, troubleshooting and resolving network problems, managing remote access networking servers, building new routers and switches, auditing and documenting network configuration, remote access implementation and administration, etc. As such, it is desirable to identify standard aspects that the jobs have in common to identify the business requirements. The lack of understanding of consistent job roles makes the development of training solutions increasingly difficult.

Accordingly, a need arises for efficient and effective tools to analyze job requirements with respect to business and technical needs, the determination of organizational skill gaps, and the appropriate training to fulfill the determined needs.

### SUMMARY

Methods, systems, and articles of manufacture of the present invention may provide a scenario-anchored database to train personnel or facilitate solution development. In one example, the database may provide work scope and/or process information to identify training requirements or enable faster solution development.

One exemplary aspect of the invention relates to a database for facilitating solution development. The database may comprise a scenario entity associated with at least one critical event, at least one of a work scope entity and a process entity associated with the scenario entity, and a core task entity associated with the at least one of the work scope entity and the process entity. The core task entity may correspond to at least one core task that facilitates solution development for the at least one critical event.

A second exemplary aspect of the invention relates to a method for facilitating solution development. The method may comprise identifying at least one critical event, associating the at least one critical event with a scenario, associating the scenario with at least one of a process and a work scope, and associating the at least one of the process and the work scope with a core task that facilitates solution development for the at least one critical event.

A third exemplary aspect of the invention relates to a scenario-based system for facilitating training. The system may comprise a scenario entity associated with at least one critical event, at least one of a work scope entity and a process entity associated with the scenario entity, a core task entity associated with the at least one of the work scope entity and the process entity, a skill entity associated with the core task entity, and a student entity associated with the skill entity. The skill entity may be associated with at least one skill for facilitating solution development of the at least one critical event. The student entity may be associated with a student that is at least one of targeted and assessed to be trained in the skill.

A fourth exemplary aspect of the invention relates to a method for facilitating training. The method may comprise determining whether a student requires training in a skill, associating the skill to a core task, associating the core task to at least one of a process and a work scope, associating the at least one of the process and the work scope to a scenario, and associating the scenario to at least one critical event. The skill may address, at least in part, the critical event.

A fourth exemplary aspect of the invention relates to a system, which may comprise a memory device, and a processor for executing a program that uses components to determine a solution to a problem corresponding to the at least one event. The memory device may include a scenario component that describes at least one event, and one or more other components associated with the scenario component.

A fifth exemplary aspect of the invention relates to a method for evaluating a scenario. The method may comprise accessing a data structure, which may include a set of entities that represent attributes associated with an organization's ability to perform at least one task, determining a relationship between one or more entities in the set of entities based on a work scenario, and identifying an individual with a first level of skill that is sufficient to at least one of correct and attempt to correct a problem associated with the work scenario.

A sixth exemplary aspect of the invention relates to a method for evaluating a scenario. The method may comprise accessing a data structure, which may include a set of entities that represent attributes associated with an organization's ability to perform at least one task, determining a relationship between one or more entities in the set of entities based on a work scenario, and identifying an individual with a first level of skill that is sufficient to at least one of correct and attempt to correct a problem associated with the work scenario.

A sixth exemplary aspect of the invention relates to a system for providing information associated with a work scenario. The system may comprise a memory device, and a processor for executing the program. The memory device may comprise a data structure that includes a set of entities, and a program for accessing the data structure and determining a subset of entities. The entities may be inter-related based on a respective association with a work scenario. The subset of entities may be related in a manner that facilitates management of an event of the work scenario.

Additional embodiments and aspects of the invention are set forth in the detailed description which follows, and in part are obvious from the description, or may be learned by practice of methods, systems, and articles of manufacture consistent with the present invention. It is understood that both the foregoing general description and the following detailed description are exemplary and explanatory only and are not restrictive of the invention as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention. In the drawings:

FIG. 1 illustrates an overview of an exemplary role analysis process in accordance with an implementation consistent with the present invention;

FIG. 2 illustrates a block diagram of an exemplary computer system suitable for use in accordance with an implementation consistent with the present invention;

FIG. 3 depicts a job having various roles in accordance with an implementation consistent with the present invention;

FIG. 4 illustrates a role with core tasks, formal training, process knowledge, technical knowledge, and critical event handling in accordance with an implementation consistent with the present invention;

FIG. 5 shows a hierarchy of components associated with personnel in an IT organization in accordance with an implementation consistent with the present invention;

FIG. 6 depicts the stages for one implementation of performing role analysis in accordance an implementation consistent with the present invention;

FIG. 7 illustrates an exemplary system for training or facilitating solution development, consistent with features and principles of the present invention;

FIG. 8 illustrates an exemplary process for training or facilitating solution development, consistent with features and principles of the present invention;

FIG. 9 illustrates an exemplary database structure for training or facilitating solution development, consistent with features and principles of the present invention;

FIGS. 10-12 illustrate exemplary matrices of work scopes with core tasks designated as specific work types, consistent with features and principles of the present invention;

FIG. 13 illustrates an exemplary work scope/role map, consistent with features and principles of the present invention;

FIG. 14 illustrates exemplary templates for entering entity information, consistent with features and principles of the present invention;

FIG. 15 illustrates exemplary relationships between entities, consistent with features and principles of the present invention;

FIGS. 16A-16D illustrate exemplary attributes of entities, consistent with features and principles of the present invention; and

FIGS. 17A and 17B illustrate additional exemplary relationships between entities, consistent with features and principles of the present invention.

### DETAILED DESCRIPTION

Organizations may make determinations of job requirements and desired training through “role analysis.” A role is a discreet job function and may comprise a set of skills. Role analysis is a process used to identify and validate high-level “core tasks” in order to clarify the work roles required by an organization for efficient and reliable operation. The role analysis process determines the extent to which the work performed by the organization's IT professionals is aligned with current or future business and/or technical requirements of the organization.

An organization may benefit from role analysis in a number of ways. For one, the organization is better able to understand the various roles of the organization, and with this understanding, it can create better training and learning-related solutions. Role analysis also permits the segmentation of training offerings more appropriately for a given audience, i.e., workers of the organization. The business-related benefits that arise from role analysis include improving role clarity and the way in which various roles align with business requirements.

Methods and systems in accordance with an implementation of the present invention perform role analysis to assist organizations with the identification of emerging technical roles related to current and future business requirements. In one implementation, methods and systems in accordance with the present invention identify roles of an organization and map the identified roles to appropriate training so that personnel may efficiently develop skills needed to perform the identified roles.

Since job roles vary worldwide with respect to responsibilities even within similar job titles, role analysis helps standardize the roles. Although within a given job title there may be considerable variance, the various job roles have certain common “core tasks.” Methods and systems in accordance with an implementation of the present invention evaluate and document the common core tasks that are needed to fulfill business requirements for an organization.

In one implementation, the methods and systems consistent with the present invention are applied to IT organizations because core tasks that are technical in nature are generally universal in the IT workplace and may be the same from all organizations. Therefore, one can generalize with validity about the performance outcomes of those core tasks as well as the training required to prepare people to perform those core tasks. As well, because role analysis may be linked to IT-related critical events, one can generalize on the training needs and requirements to perform disaster recovery, etc. Other implementations, however, may also be used.

In one implementation, the methods and systems consistent with the present invention may also use role analysis documentation to provide at least four deliverables: (1) a roles and responsibility matrix, (2) team structure design, (3) custom job descriptions, and (4) staffing level recommendations. A roles and responsibility matrix is a summary, i.e., table or matrix, or mapping of commonly used areas of responsibilities to roles. A team structure design is a high-level description of how the team will be organized to perform various technical functions. Custom job descriptions are summaries of a given job's areas of responsibilities and core tasks, customized to meet the organization's unique needs. Finally, staffing level recommendations are projections for staffing roles based upon a determination of needs. Other implementations, however, may also be used.

In one implementation, the methods and systems consistent with the present invention may also provide certain results. For example, the methods and systems may produce a completed role analysis report using a “Role Analysis Survey” format. The methods and systems may also produce a “core task” template (described below) that maps an organization's roles to certification training requirements, such as SunTone™ certification from Sun Microsystems, Inc. These methods and systems may be performed by computers or people or various combinations of both. Other implementations, however, may also be used.

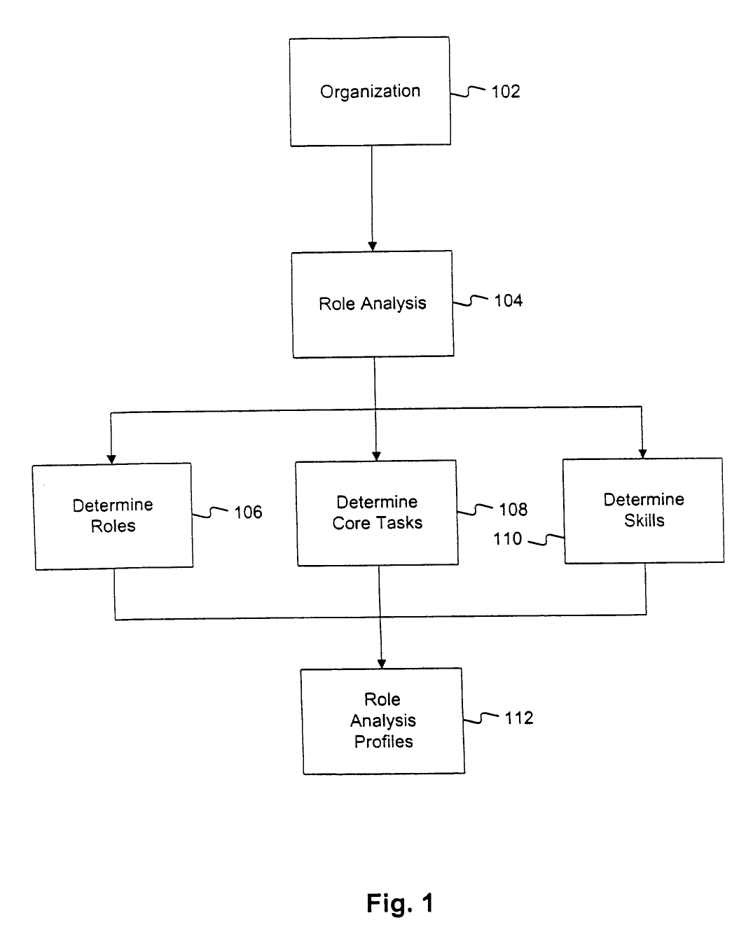

FIG. 1 illustrates a diagram of an overview of a role analysis process in accordance with an implementation consistent with the present invention. An organization (stage 102) decides to have role analysis performed on the organization (stage 104) to evaluate personnel and training needs. To do so, information is gathered and the organization is examined to determine the roles (stage 106), core tasks (stage 108) and skills (stage 110) of personnel of the organization (these terms are described in detail below.) Finally, the roles, core tasks and skills are interpreted and compiled to create role analysis profiles, also described below, which, in one implementation, may be used by an organization to determine training needs, arrange personnel, determine skill gaps, etc.

Computer Architecture

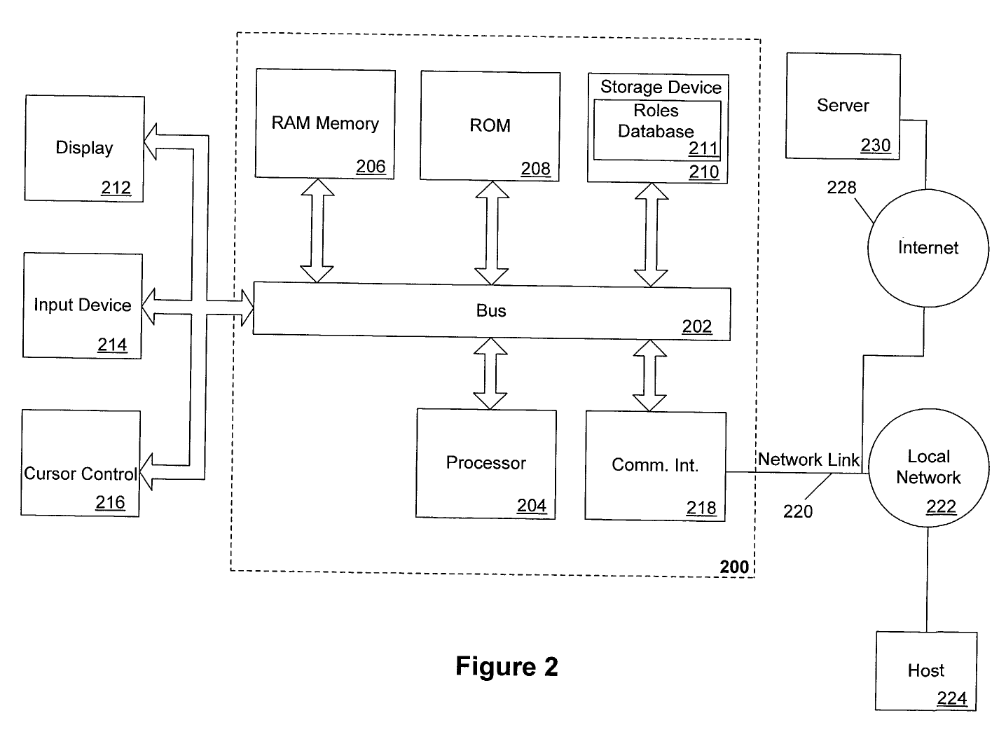

FIG. 2 is a block diagram that illustrates a computer system 200 in which methods and systems consistent with the present invention may be implemented.

Computer system 200 includes a bus 202 or other communication mechanism for communicating information, and a processor 204 coupled with bus 202 for processing information. Computer system 200 also includes a main memory 206, such as a random access memory (“RAM”) or other dynamic storage device, coupled to bus 202 for storing information and instructions to be executed by processor 204. Computer system 200 further includes a read only memory (“ROM”) 208 or other static storage device coupled to bus 202 for storing static information and instructions for processor 204. A storage device 210, such as a magnetic disk or optical disk, is provided and coupled to bus 202 for storing information and instructions. Storage device 210 or memory 206 may contain roles database 211, which may store, among other things, previously created roles and associated core tasks, training requirements, process knowledge and technical knowledge, and critical events.

Computer system 200 may be coupled via bus 202 to a display 212, such as a cathode ray tube (“CRT”), for displaying information to a computer user. An input device 214, such as a keyboard, is coupled to bus 202 for communicating information and commands to processor 204. Another type of user input device uses cursor control 216, such as a mouse, for communicating with processor 204 and for controlling cursor movement on display 212.

Computer system 200 also includes a communication interface 218 coupled to bus 202. Communication interface 218 provides a two-way data communication coupling to a network link 220 that may be connected to local network 222. For example, communication interface 218 may be a modem, for example, to provide a data communication connection. As another example, communication interface 218 may be a local area network (“LAN”) card to provide a data communication connection to a compatible LAN or a wireless network card to provide a connection to a wireless network. Communication interface 218 sends and receives electrical, electromagnetic, or optical signals that carry digital data streams representing various types of information.

Network link 220 typically provides data communication through one or more networks to other data devices. For example, network link 220 may provide a connection through local network 222 to a host computer 224 or to a wide area network (“WAN”), such as the Internet 228. Local network 222 and Internet 228 both use electric, electromagnetic or optical signals that carry digital data streams. The necessary signals through the various networks and the signals on network link 220 and through communication interface 218, which carry the digital data to and from computer system 200, are exemplary forms of carrier waves transporting the information.

Other implementations may also be used for computer system 200 or for the components connected to computer system 200 via bus 202 or communication interface 218.

Method and System Details

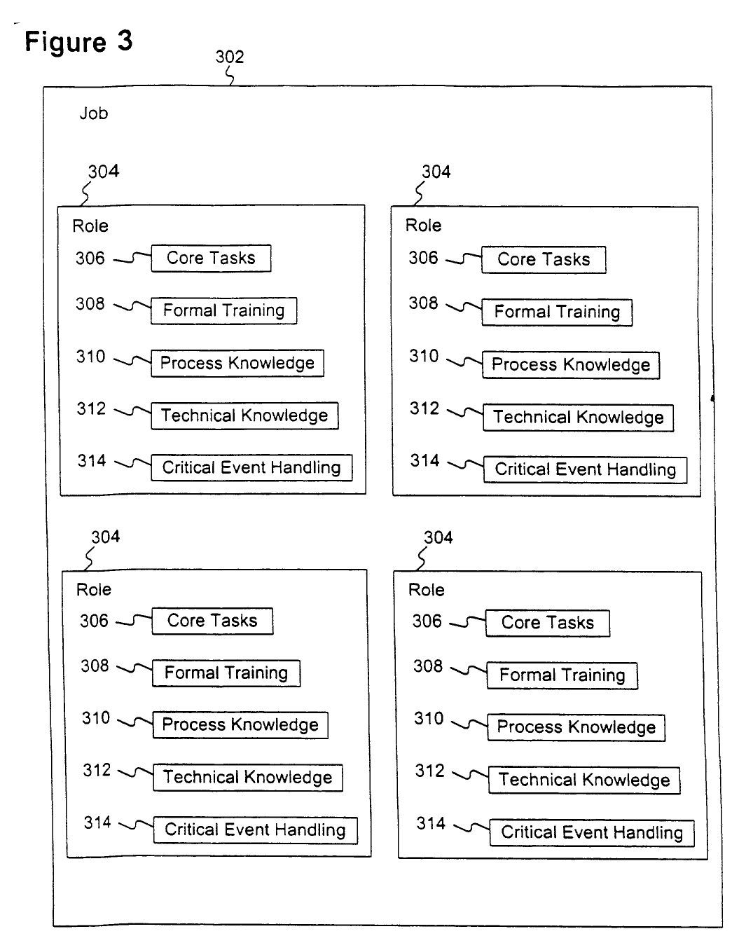

FIG. 3 depicts a job 302 having associated roles 304 with core tasks 306 and skills 308-314 in accordance with an implementation of the present invention. A role 304 is a discreet job function, and in one implementation, a job function becomes a role 304 when at least 20% of the worker's time involves performing that function. Within a given job 302, there may be several roles 304. One criterion of a role 304 is that it requires knowledge and skill in a specific technical area for performance, and an example of a specific role is “Solaris™ System Engineer.” In this implementation, role 304 comprises a set of core tasks 306 and a set of skills including formal training 308, process knowledge 310, technical knowledge 312, and of critical event handling 314. In this implementation, roles 304 are mapped to skill, training, and problem solving areas that have been established over time and are well defined in roles database 211. Other implementations may also be used.

For example, new roles 304 may be defined in terms of new core tasks 306 and set of skills 308-314, e.g., that need to be performed when a new technology, emerges in the market. Thus, as organizations acquire new technology, there are corresponding new roles 304 that arise, and these new roles 304 need to be defined by way of and mapped to core tasks 306. These new roles 304 may be added to the database as they develop.

Roles 304 are mapped to core tasks 306, which are high-level performance activities and may be used as defining units of performance for a role. For example, a core task 306 in an IT organization may be “to provide database administration.” Core tasks 306 are units of performance or “performance activities” that are common across IT technologies. Core tasks 306 may also complete a milestone or step in a process, which is the defining sequence of events, steps or phases that need to be performed in order to meet business requirements. In one implementation, one test of a core task 306 is that it can be mapped to a core process and/or to a high-level output needed to meet a business requirement.

In one implementation, role 304 may be either a “functional role” 304 and “product specific role” 304, which are both different types of roles 304 and are described below. A “functional role” 304 may be defined by a set of core tasks 306 needed to perform an activity unique to a role. For example, a functional role 304 of a relational database administrator may commonly involve several core tasks 306, such as: 1) providing database administration, 2) planning capacity for databases, 3) performing backup and restoration, 4) performing trouble-shooting, and 5) performing tuning. A functional role 304 may also be defined by researching industry standards and evolving technology. Evaluation of functional roles 204 may lead to solutions such as job descriptions, staffing level estimates, and team structure. A functional role 304 may also be, to some extent, the foundation for product-specific roles.

A “product specific role” 304 may be defined by a set of core tasks 306 required to perform an activity unique to a specific product. A product specific role 304 may be created by taking the core tasks from a functional role and customizing them to a particular product or by utilizing existing product-specific courseware. For example, a product specific role 304 for a relational database administrator may be for example, those roles associated with such database products as Oracle, Sybase, Informix, or DB2. Generally, a product specific role 304 is used to assess an organization's skill level relative to a specific product.

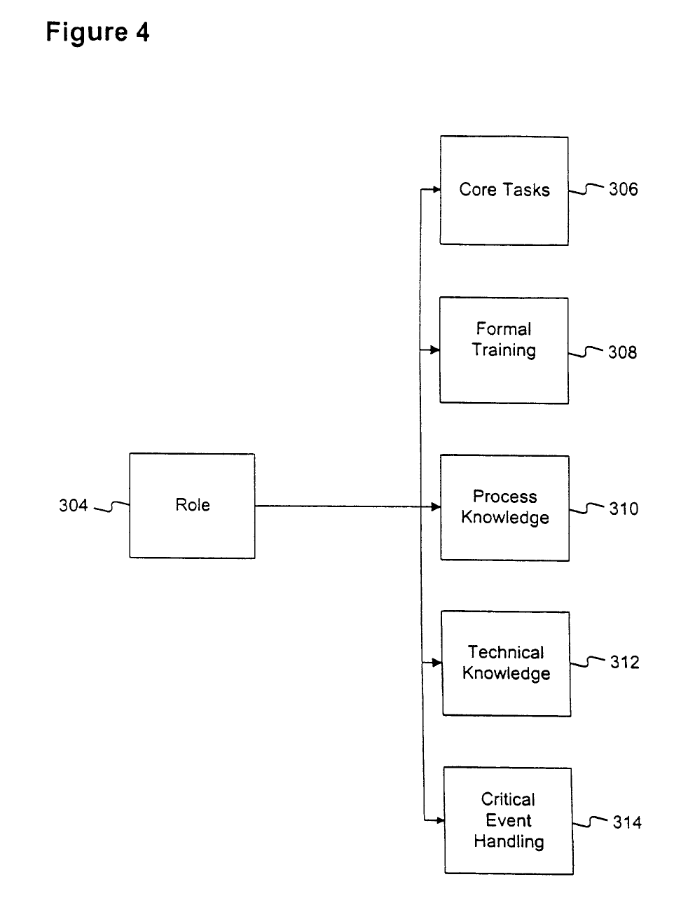

A core task 306 is a performance activity held in common across an area of IT technology. In the IT business, because of the consistency of core tasks 306, roles 304 may be determined in advance. Because core tasks 306 are linked to a technology or skills, they are dimensions of performance that allow for the development of pre-determined roles 304 which define a set of skills needed to perform in a given area of technology and may be stored in the roles database 211. In one implementation in accordance with the present invention, the information gathered during the role analysis process is compared to the core tasks 306 and pre-determined roles 304 contained in the role database 211. Additional components of FIG. 3 are discussed in regard to FIG. 4.

FIG. 4 is a more detailed view of a role with core tasks, formal training, process knowledge, technical knowledge, and critical event handling in accordance with an implementation consistent with the present invention. FIG. 4 shows that, in one implementation, each role 304 has associated (1) core tasks 306, (2) formal training 308, (3) process knowledge 310, (4) technical knowledge 312, and (5) problem solving skills 314 required to handle critical events. Generally, formal training 308 involves the level of formal training required to perform the role. Process knowledge 310 involves work instructions, procedures, etc., and technical knowledge 312 represents knowledge involved in operating and handling various software, hardware, etc. Furthermore, a critical event is an occurrence that shuts down a system or process to the extent that there is a negative business impact in terms of service level agreements and/or other expected business outcomes.

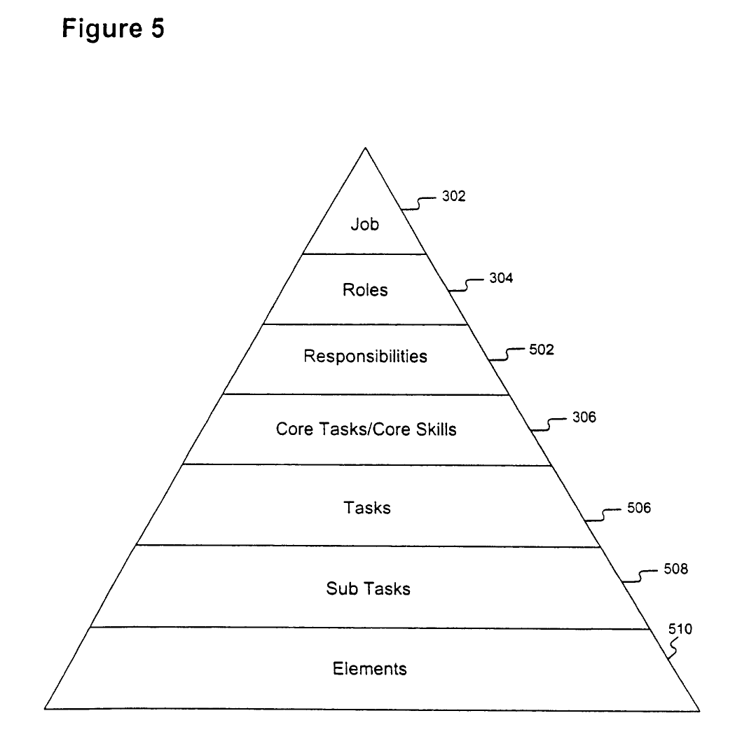

FIG. 5 shows a hierarchy of components associated with a job 302 in an IT organization. In this implementation, a role 304 is a discreet job function related to a technical work requirement. Within a given job 302, there may be a number of functional roles 304.

A “responsibility” 502 is a high-level accountability area or component of a role 304 that maps to both levels of required skills as well as levels of required performance. In one implementation, a criterion test of a responsibility 502 is a goal or series of performance requirements for which the job incumbent is held accountable. An example of a responsibility 502 is “to design a SunRay™ system to ensure availability and reliable performance.” Responsibilities 502 may also be used to write custom job descriptions, discussed below.

As previously mentioned, core tasks 306 are high-level components of a role 304. A criterion test of a core task 306 is that it can be mapped to the core business process. A core task 306 may complete a milestone in a core process, and core tasks require specific levels of knowledge and skill to perform in a technical area. An example of a core task 306 is “to specify network infrastructure needed.”

“Tasks” 506 are what must be accomplished on the job or, in other terms, the performance result expected. They are more specific than a core task 306. In one implementation, the criterion test of a task is an output or performance result. The output of a task can be assessed against specific criterion in terms of quality, quantity, timeliness, appropriateness, etc. An example of a task is to “in accordance with guidelines, identify by number specifications for ethernet cable needed.”

In contrast, a skill is a level of proficiency with respect to how the task is performed or how well the task is accomplished. Skills and knowledge, i.e., know-how, are brought to the work by a job incumbent. Knowledge and skills are pervasive throughout the role and task hierarchy. The job incumbent applies skills to produce the output. The criterion test of a skill (or know-how) is that it is a required element in the process to produce the output.

“Sub-tasks” 508 are more detailed components of a task. Knowledge and skills are pervasive throughout the task and sub-task hierarchy. An example of a sub-task is to “verify that switches are daisy-chained in accordance with design.”

“Elements” 510 are more detailed components of a sub-task. Knowledge and skills are pervasive throughout the sub-task and element hierarchy. An example of an element is to “verify by count and documentation process that the number of switches does not exceed specification.”

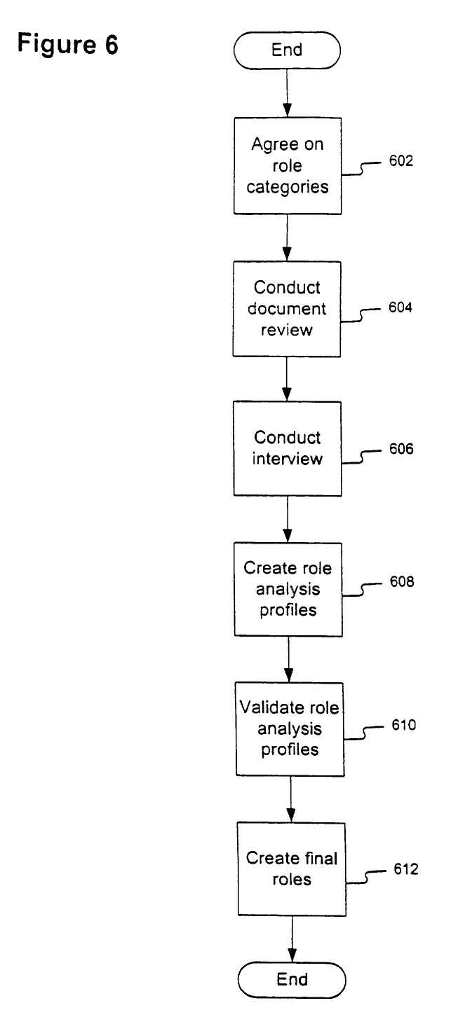

FIG. 6 shows the stages for one implementation of performing role analysis in accordance with the present invention. Many of these steps may be performed by a computer or a person (or persons), or a combination of both. Many of the steps may be performed by a person entering information into a computer that is transmitted over a network to a computer such as computer 100 having a roles database 211. The person or persons performing role analysis steps are referred herein to as “consultants.” Also, the entity, company or group that is being analyzed is referred to as the “organization.”

As shown in FIG. 6, consultants agree on “role categories” with the organization (stage 602). Role categories are high-level technical functional areas such as system administration, network administration, storage administration, security, etc. The determination of role categories assists in the segmentation of the audience (workers of the organization) for further analysis, and the managers of the organization segment the audience for data gathering purposes based on the role categories into audience segments. The consultants determine subject matter experts from each audience segment (i.e., group of workers in a role category) and role category, and in one implementation, acquire management approval for the subject matter experts to participate in the role analysis. The subject matter experts may be people particularly knowledgeable in their field or segment. The consultants also determine applicable documentation to be analyzed in the process. The consultants may meet with managers to review and sign off on the plan and process.

The consultants work with their respective audience segments to conduct document review of the organization's relevant documents and documents provided by the managers (stage 604). These documents may include processes, position descriptions, learning content, and product manuals. In collecting documents, consultants may also receive job descriptions, and product and technology descriptions and analyze what the organization is doing, what job descriptions are lacking, and what the organization has to do. The consultants check the existing roles 304 predefined in the roles database 211 to see if they are consistent with the documents being reviewed. In addition, they prepare “core task templates” to use as interview tools. These core task templates may also be stored in roles database 211. An exemplary core task template is shown in Appendix A. As shown, in one implementation, the core task template includes areas for questioning in five areas, which are described below.

The consultants then interview the subject matter experts, appropriate workers, or key contributors in an audience segment about roles 304 and core tasks 306 (stage 606). For each job 302, the consultants ask what must be performed to do the job. The consultants explore these areas and evaluate what roles 304 are needed. The consultants then edit and update the core task templates as a result of each interview, and store them in the database 211.

In one implementation, consultants interview the subject matter experts using a five-question format, consistent with the core task template. The five questions are directed to determining core tasks 306, formal training 308, process knowledge 310, technical knowledge 312 and handling of critical events 314 for a given role, as shown in FIG. 4.

The first area of questioning involves the technical core tasks 306 required for the role 304. The consultant asks the subject matter expert what are the core tasks needed for this role 304 to determine the core tasks 306. A second area of questioning is the prerequisites required in terms of training/education 308 and level of experience. A relevant question regarding this area may be “what formal training and/or experience would serve as a prerequisite for this role?”

A third area of questioning regards the process knowledge 310 required which include types of procedures, work instructions, install guides, etc. A consultant may ask the subject matter expert to describe the role 304 in terms of process knowledge, i.e., the “how-to's,” procedures, work instructions, etc. A fourth area of questioning is technical knowledge 312 required for types of hardware, platform, etc. The subject matter expert may be asked to describe the role 304 in terms of technical knowledge needed, i.e., the “what's” in terms of hardware, software, etc.

A fifth area of questioning is the level of technical problem-solving 314 required to solve “critical events.” In this questioning, the subject matter expert may be asked to give an example of a trouble shooting challenge, technical problem, or critical event. The answers to these questions are recorded on the core task templates.

In one implementation, consultants compare the responses to the interview questions with roles 304 in the database 211. They get core task 306, training 308, process knowledge 310, technical knowledge 312, and critical event handling 314 information from the subject matter experts and compare it to the roles 304 in the existing roles database 211. If the appropriate roles 304 are already in the database 211, then the information from each existing role is accessed. For a given role 304, the computer may report what skills set (training 308, process knowledge 310, technical knowledge 312, critical event handling 314) are typically needed for that role using the role that is in the database 211. In another implementation, the consultant may access the database 211 and present, for example, the 25 most used roles 304 from database for comparison and analysis. In one implementation, the role database 211 comprises on the order of 100 or more roles 304.

If the role 304 is missing parts in any portion of the training, process knowledge and technical knowledge, then they may be added. If the role 304 is not in the database 211, a new “emerging” role is created accordingly and that role may be added to the role database 211 if it might be reused, possibly by another organization. The role analysis information is maintained in the role database 211, and the database is updated as new jobs, roles, etc. are created throughout the analysis.

One goal of the interview process is to determine if the right core tasks 306 are being used for a given role 304. Generally, the consultants ask the subject matter experts if the consultants are using the right core tasks 306 for the roles 304 that have been chosen. The consultants may either add, delete, or change a core task 306 for a given role 304 if it is not appropriate for the organization. If there are inconsistencies between the roles 304 in the database 211 and the information received from the organization, the consultants check to see if they are performing different roles 304 or different levels of the same role.

Next, the consultants compile the recorded core task template information and group templates by common tasks or responsibility and compile interview data to create “role analysis profiles” also referred to as “straw man” roles (stage 608). In one implementation, role analysis profiles are completed roles 304 having lists of core tasks 306, training 308, process knowledge 310, technical knowledge 312, and critical event handling 314 for a given role.

Tables 1-5, for example, show a sample role analysis profile for the role 304 of middleware specialist.

TABLE 1
Sample role analysis profile for the role of Middleware specialist
Role: This role supports efforts to transform customers' enterprises
to become Internet based.

1. Are these the core tasks for this role?
Develop middleware architectures for customers.
Integrate new applications with legacy systems.
Design and maintain three-tier architecture for customers' enterprises.
Analyze development specifications for applications.
Maintain documentation for middleware designs.
Evaluate new middleware products.
Assist e-commerce programmer in design and development.
Design and configure monitoring procedures for middleware products.
Analyze new versions of existing middleware products and
recommend upgrades.
Maintain operations support manuals with up-to-date middleware
troubleshooting information.

TABLE 2
Sample role analysis profile: Middleware specialist (continued)
2. What formal training and/or experience would serve as a prerequisites
for this role?

Middleware Specialist
Solaris System Admin I (SA-238)
Solaris System Admin II (SA-288)
Solaris TCP/IP Admin (SA-389)
Intro to Netscape Server Infrastructure for E-Commerce
Applications (ECR-2186)
Developing J2EE Compliant Enterprise Java Applications (FJ-310)
Advanced Development with iPlanet Application Server 6.0 (NAS-4211)

TABLE 3
Sample role analysis profile: Middleware specialist (continued)
3. Describe the role in terms of the process knowledge needed?
(i.e, the “how-to's”, procedures, work instructions, etc.)

Assessment of capacity requirements
Development of application architecture
Evaluation of applications
Integration of new applications
Design and maintenance of three-tier architecture
Analysis of existing products

TABLE 4
Sample role analysis profile: Middleware specialist (continued)
Describe the role in terms of the technical knowledge needed?
(i.e. the “what's” in terms of hardware, software, etc.)

Knowledge of major framework components such as MQ series,
ORBs/CORBA, middleware routing engines, DCE across
heterogeneous
(UNIX,NT) platforms.
Knowledge of enterprise level middleware architecture
Knowledge of three-tier architecture

TABLE 5
Sample role analysis profile: Middleware specialist (continued)
5. What level of technical problem-solving skills is required?
(Give an example of a trouble-shooting challenge, technical
problem, or critical event)

Solves high integration problems with new applications
Nonroutine enterprise level troubleshooting and diagnosis for
middleware products

Appendix B shows examples of completed role analysis profiles. As shown in Appendix B, the completed role analysis profiles are provided, including the appropriate roles 304 having the determined core tasks 306, formal training 308, process knowledge 310, technical knowledge 312 and critical event handling skills 314 for the role. For example, the first role analysis profile shown in Appendix B illustrates an exemplary role analysis profile for an exemplary network architect in an organization. In this example, the information in role analysis profiles were determined from the information gathering process including documentation review and interviewing.

Next, the consultants review the draft role analysis profiles with the subject matter experts in the respective audiences to validate the role analysis profiles (stage 610). In one implementation, these subject matter experts are different subject matter experts than the ones who were interviewed to create the role analysis profiles. The subject matter experts provide feedback, and the consultants make any additions and/or corrections to the role analysis profiles that are desired for that audience segment. The consultants then finalize the report and deliver it back to the managers of the organization (stage 612).

The managers utilize the role analysis profiles to identify skill/knowledge gaps as well as to coach staff with respect to job requirements. Furthermore, the role analysis and role analysis profiles may be leveraged by managers to other technical areas. Managers are able to save both time and reduce hiring costs through the use of the role analysis to target better hiring, by, for example, combining jobs, targeting better candidates, and eliminating unnecessary core tasks 306.

In one implementation, roles 304 and/or core tasks 306 are mapped to specific training requirements, such as SunTone™ certification, for managers. Because a technology has a defined set of core tasks 306, the core tasks can be associated with training courses, and consultants can determine what training is needed for an audience segment of an organization based on the role analysis profiles. Appendix C shows examples of a mapping of roles 304 and core tasks 306 to associated training. As shown in Appendix C, correlations may be drawn from certain core tasks or groups of core tasks to specific training. By analyzing the roles, core tasks and role analysis profiles of an organization, a specific mapping may be made from the core tasks to training programs. This mapping may be stored, for example, in the roles database 211, and may also be progressively developed over time. Using the finalized role analysis profiles and associated core tasks 306, the computer 200 can output the needed associated training based on the mapping of associated training to core tasks, or categories of core tasks, stored on the computer.

Alternative Embodiments

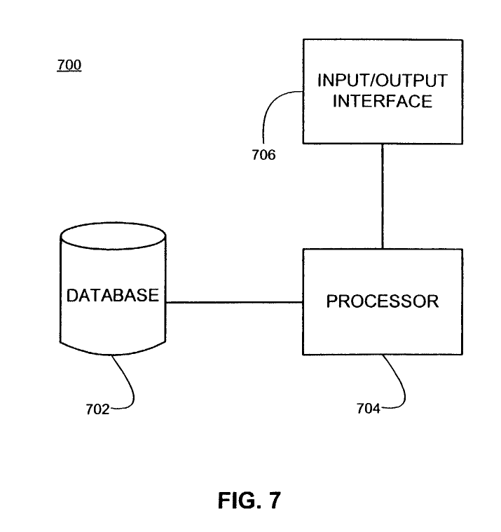

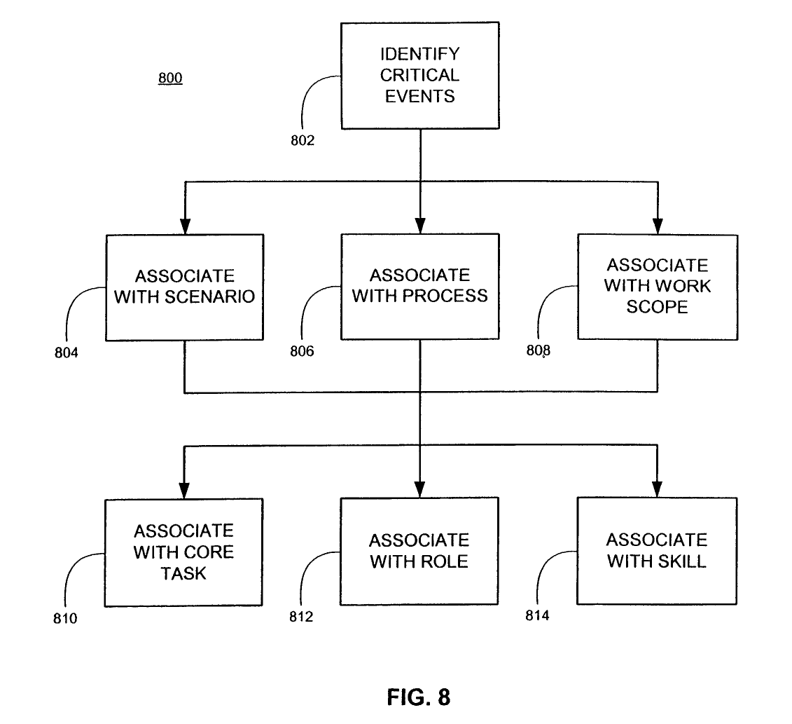

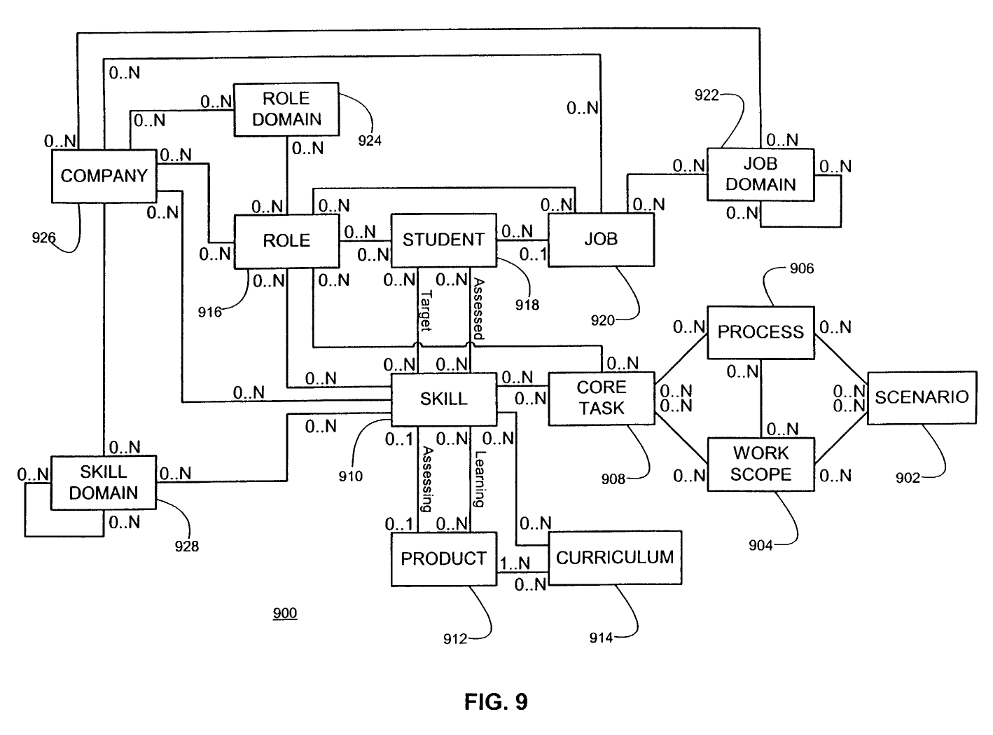

Methods, systems, and articles of manufacture consistent with the present invention may provide a scenario-anchored database that includes work scope and/or process information to identify training requirements, provide training, or facilitate faster solution development. Embodiments of the present invention may include a system 700, illustrated in FIG. 7. As described in more detail later herein, system 700 may be configured to implement a process 800, illustrated in FIG. 8, and may generate a database structure 900, illustrated in FIG. 9, based in part on role analysis.

As described above and illustrated in FIGS. 3 and 4, a role analysis may identify critical events. A critical event may be an opportunity that has a potential to negatively impact or advance a business. Some nonlimiting examples of critical events may include an immediate problem requiring urgent attention, an important project milestone, a contractually obligated commitment, etc. The critical event(s) may define and bound a scenario (i.e., one or more inter-related critical events may together form a larger issue or picture). In turn, the scenario may enable and support definition of a process or a work scope that are associated with one or more core tasks. Core tasks may be activities that facilitate solution development or implementation for the critical event(s) or scenario (i.e., address/correct or attempt to address/correct problems encountered in the scenario). Any core task that advances resolution of the critical event or the scenario may facilitate solution development or implementation.

Each core task may be associated with one or more roles or skills. Personnel assigned to these roles or having the required skills may be identified to perform core tasks that will facilitate development or implementation of the solution. For example, in a scenario, a client computer workstation may be “frozen” (i.e., unresponsive to input from a user). In order to “unfreeze” the client workstation (i.e., make the workstation responsive to the user), the client workstation's server may have to be shutdown and restarted. A core task associated with this scenario may require appropriately trained personnel to properly shutdown and restart the server. Hence, performing the core task facilitates development and implementation of a solution for (i.e., helps address or fully addresses) the client workstation's “frozen” problem by restarting the server to “unfreeze” the client workstation.

If the skills of personnel assigned to a role cannot adequately facilitate solution development or implementation, then the personnel may be targeted or assessed as students for training to develop these and/or other additional skills. The defined scenarios may be presented to instruct the personnel how to appropriately handle the scenarios or critical events in the scenarios.

As illustrated in FIG. 7, a system 700 for training or facilitating solution development, consistent with features and principles of the present invention, may include a database 702, a processor 704, and an input/output (I/O) interface 706. Database 702 and I/O interface 706 may be coupled to processor 704.

Database 702 may be implemented by any mechanism (e.g., RAM, ROM, magnetic media, printed media, optical hard drives, organic storage devices, etc.) for storing information that is known in the art and compatible with the present invention. Processor 704 may be implemented by any device or system (e.g., a computer, an electronic device, a mechanical device, an application specific integrated circuit, a microprocessor, etc.), known in the art and compatible with the present invention, for handling or manipulating information. I/O interface 706 may include any mechanism (e.g., a keyboard, a mouse, a scanner, a monitor, a printer, etc.) for receiving or presenting information.

Any of database 702, processor 704, and I/O interface 706 may be coupled together using a direct connection (e.g., a data bus, a direct wire link, etc.), an indirect connection (e.g., an indirect wireless link, etc.), or any other mechanism for facilitating transfer of information. For example, any of database 702, processor 704, and I/O interface 706 may be coupled together using a network. A network may include any device or system for permitting communication between two or more nodes or remote locations (e.g., an Ethernet network, an Internet Protocol network, a telephone network, a radio network, a cellular network, etc.).

According to features and principles consistent with the present invention, system 700 may be configured to implement a process 800, illustrated in FIG. 8, for training or facilitating solution development. Process 800 may be a program (e.g., set of process instructions, commands, etc.) that, when executed by processor 704, may perform functions consistent with certain features related to the present invention. The program (i.e., process 800) may be stored on database 702, or, alternatively, on another memory device remote to system 700 (e.g., floppy disk, compact disc, other computer-readable medium, permanent or temporary storage device, etc.).

In one aspect of the invention, methods and systems consistent with certain features and principles of the present invention may facilitate solution development by identifying critical events (step 802). A critical event may include any potential or actual problem, situation, circumstance, goal, task, etc. that may be deemed important to a business. For example, a critical event may be an occurrence that shuts down a system or process to an extent that there is a negative business impact in terms of expected business outcomes or service level agreements (e.g., monetary penalties in computer maintenance contracts or service warranties for not providing adequate computer support, etc.). Alternatively, or additionally, a critical event may be associated with an opportunity to benefit from a potential positive business impact.

Critical events may be determined using role analysis. For example, during role analysis, subject matter experts (or other entities/individuals) may identify and define critical events by answering questions and surveys that help them isolate and categorize the critical events. Examples of such questions and surveys, and other methods of identifying critical events are described above and illustrated in Tables 1-5, FIGS. 1-6, and Appendices A and B.

Further, critical events may be technical or nontechnical critical events as discussed below. Some technical and nontechnical critical events may be inter-related and experts may associate these critical events with a scenario (step 804). For example, consider a scenario that involves a call dispatch center sending a technician to a client for on-site support. The client's computer system may repeatedly reboot against the wishes of the client and no one at the client's site may have time or the patience to troubleshoot the problem over a telephone. Consequently, the client may request that the technician arrive on-site as soon as possible to address the problem. Further, this may be the second time the technician has handled this type of problem, so the technician may realize that he needs to escalate the problem and speak with more experienced technicians. However, due to a current reorganization of the technician's company, there may be unclear roles with respect to two internal teams in the company that the technician may obtain assistance with the problem. Also, upon arrival at the site, the technician may discover his key contact is away on vacation.

Experts may associate the above-exemplary scenario with a technical critical event, such as a corrupt operating system that causes the client's computer to constantly reboot. This technical critical event may be one of a set of possible technical critical events stored in a database (e.g., database 702). Experts may generate scenarios based on any of the stored critical events to train or test personnel. Additionally, the experts may associate nontechnical critical events, such as no back-ups for trained and experienced, key staff, and a company reorganization, wherein the reorganization appears to create unclear roles among two teams (i.e., a Fault Management Team and a Performance Management Team). As one of ordinary skill in the art can appreciate, other scenarios involving other types of critical events (e.g., only technical critical events, only nontechnical critical events, or both technical and nontechnical critical events) may be implemented without departing from the scope of the present invention.

According to features and principles of the present invention, a scenario may require certain process knowledge or work scopes to handle the critical events included in the scenario. Process knowledge may include work instructions, procedures, etc. Work scope may include types of work performed in a given role. A role may be a discreet job function, and in one implementation, a job function may become a role when a certain percentage (e.g., 20%, 30%, etc.) of a worker's time involves performing that function. An appropriate series of interview or focus groups may identify the types of work in a role. Experts may associate the required process knowledge or work scopes with the scenario and its critical events (steps 806 and 808). Experts may also define core tasks that need to be completed in the process and may associate the core tasks with the process (step 810). Further, core tasks may be defined under each type of work and associated with the work scope (step 810). Various types of work may be identified, including, for example, core work, support work, and boundary work.

Core work may include core tasks that are primary work for a given role. By way of a nonlimiting example, if a worker has primary work responsibility and accountability for a given core task, the core task may be considered core work for the worker.

Support work may include core tasks linked to a role, but a worker may not have primary work responsibility for the core tasks. By way of a nonlimiting example, if a worker's core task enables the work of others, the core task may be considered support work for the worker.

Boundary work may include core tasks that are external to a worker's primary work responsibility. By way of a nonlimiting example, if a worker needs to have knowledge (e.g., updates, status, etc.) about a core task to perform a role and is not responsible for or supporting the core task, then the core task may be considered boundary work for the worker.

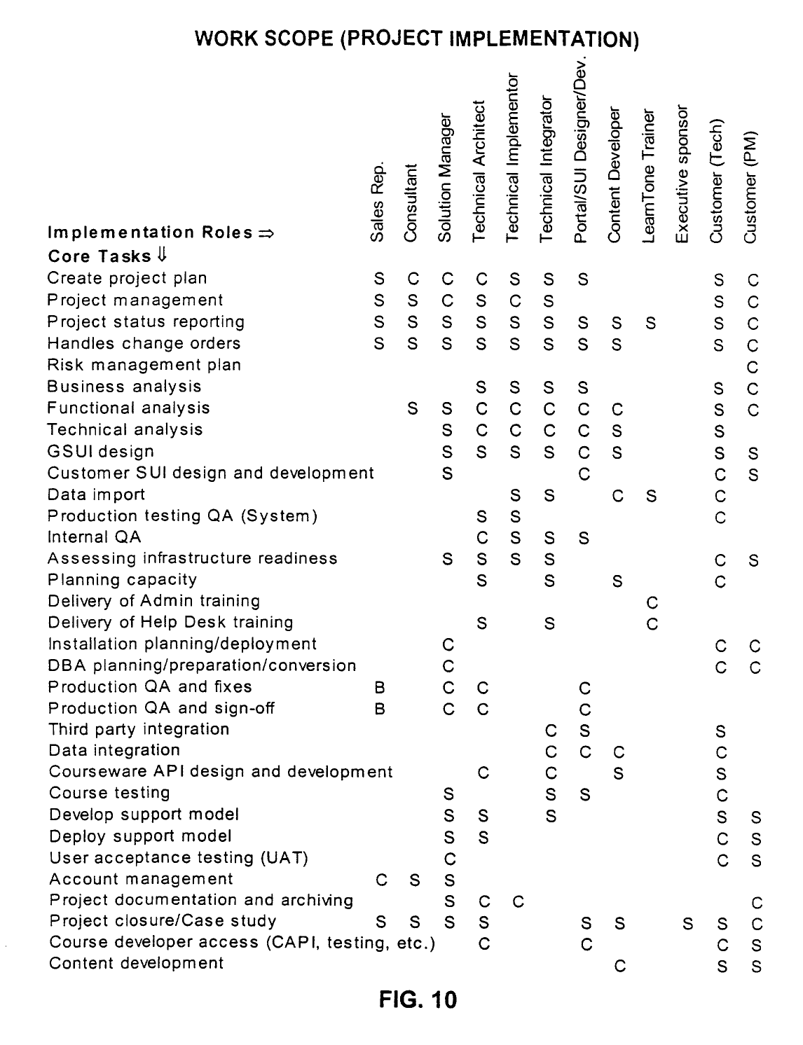

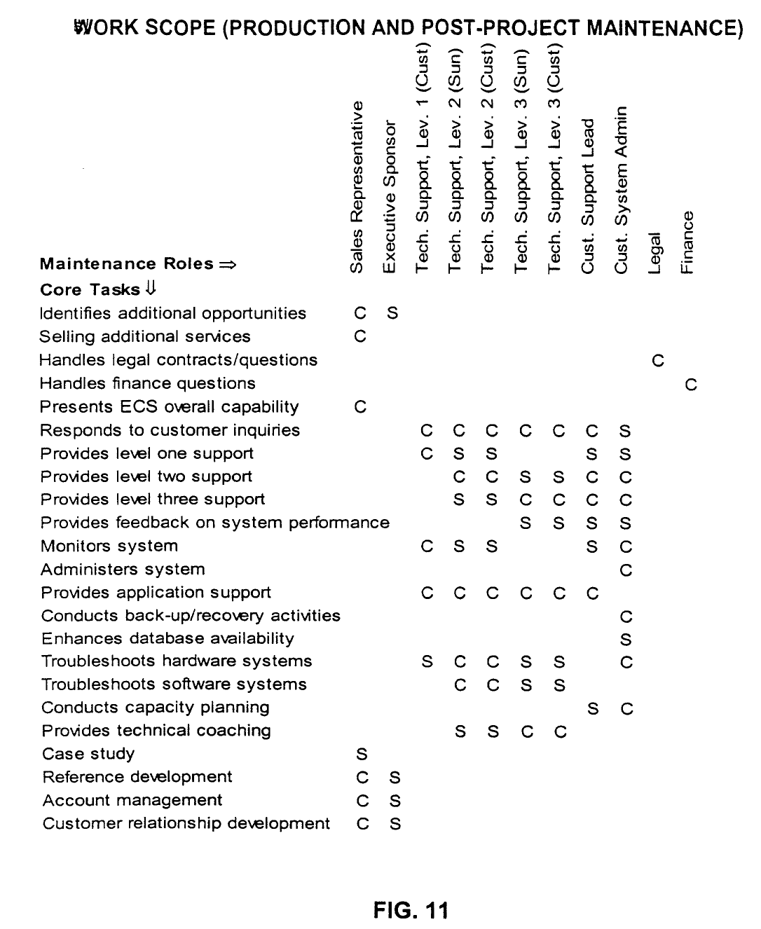

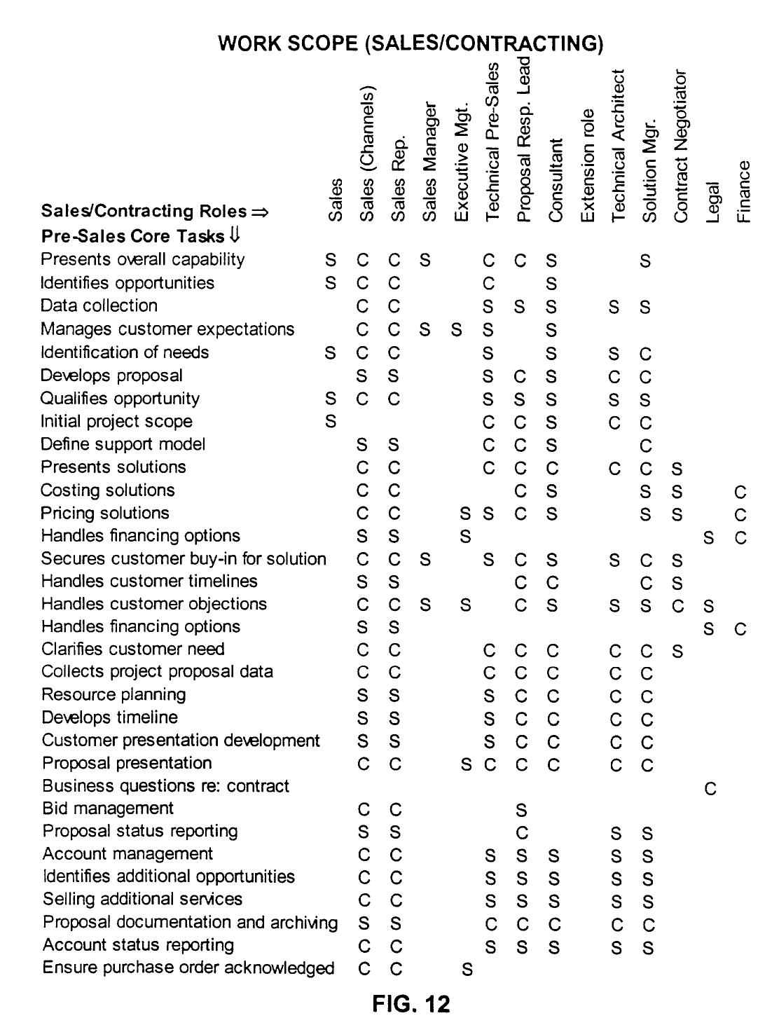

FIGS. 10-12 illustrate exemplary matrices of work scopes with core tasks designated as specific work types (C=core work, S=support work, and B=boundary work) for different roles. For example, in FIG. 10, the work scope of a sales representative role may include support work, such as creating a project plan, project management, project status reporting, handling of change orders, and project closure/case study. The work scope of the sales representative role may further include core work, such as account management, and boundary work, such as production quality assurance (QA) and fixes, and production QA and sign-off.

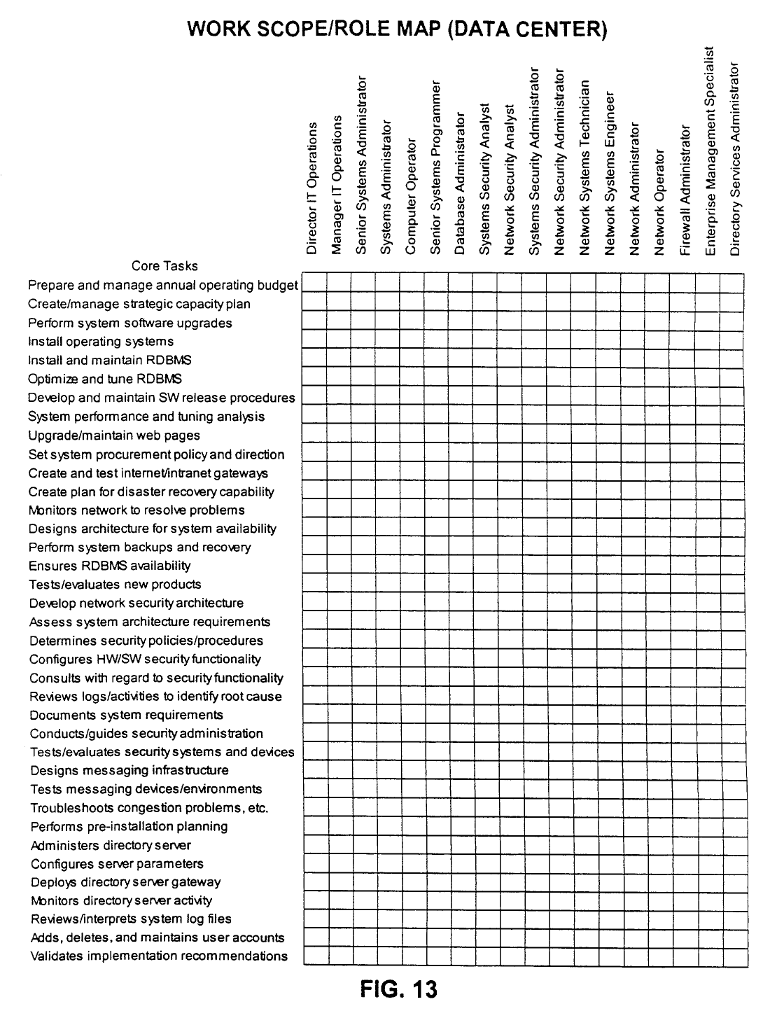

The act of designating the work types of core tasks in a work scope for a given role may, in itself or as a separate step, associate core tasks with the role (step 812 of FIG. 8). By way of a nonlimiting example, FIG. 13 illustrates an exemplary work scope/role map that may be used to associate core tasks with data center roles. Subject matter experts may determine which core tasks fall within the work scope of a given data center role by completing the work scope/role map (i.e., entering C, S, or B at the appropriate spaces in the map) and thus associate core tasks with the role.

In the above description, core tasks are designated as one of three exemplary work types. However, as one of ordinary skill in the art can appreciate, additional work-type designations may also be used. For example, the designations may include “N” for a new or emerging core task or “G” for a gap in existing skills or training. That is, a role with a pre-existing work scope may have a new core task added to the role or a role may not have the skills or training (i.e., a gap) to complete a core task already assigned to the role. Additional work types may also be used.

According to features and principles of the present invention, experts may also associate core tasks with skills (step 814). A skill may include formal training, process skills, technical skills, or critical event handling (e.g., problem-solving skills), as described above. A skill may involve a level of proficiency with respect to how the core task is performed or how well the core task is accomplished. Some exemplary skills may include nonroutine network trouble-shooting, logical modeling, physical modeling, UNIX administration, an educational degree, a certification, etc..

In one embodiment of the present invention, the associations performed in process 800 (FIG. 8) may be incorporated into database structure 900 (FIG. 9). A user may employ system 700 (FIG. 7) to create database structure 900. Database structure 900 may comprise entities 902-906 that represent various items (e.g., scenarios, skills, roles, etc.) identified during role analysis. An entity may be any data structure or mechanism used to represent the items and attributes of the items. As one of ordinary skill in the art can appreciate, an entity may be implemented in database structure 900 using a record, a computer program component, a software component, an object, a file, allocated memory, or any other type of software data structure.

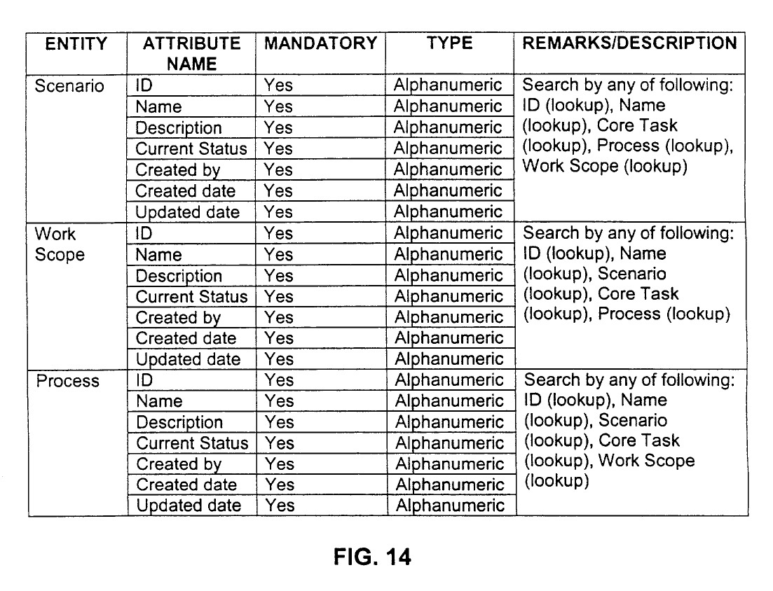

For example, a user may create a scenario entity 902 based on scenarios generated by subject matter experts as described above. The scenario entity may be stored as a record in database 702 (FIG. 7). The user may use I/O interface 706 to enter information associated with the scenario by completing one of the scenario entity templates illustrated in FIG. 14. The entered information may include identification (ID), name, description, current status, created by, created date, or updated date attribute information, as well as other attribute information. Database 702 may use the ID attribute to index the scenario entity. The name attribute may label the scenario entity as a particular scenario. The description attribute may provide detailed information regarding the scenario. The current status attribute may indicate the state of the scenario entity. The created by and created date attributes may identify who created the scenario entity and when it was created, respectively. The updated date entity may specify when the scenario entity was modified.

Similarly, the user may create a work scope entity 904 or a process entity 906, based on a respective work scope or process as described above. The user may enter information for entities 904 or 906 using a work scope entity template or a process entity template illustrated in FIG. 14, respectively.

Once formed, the user may create, using processor 704, desired relationships between entities 902-906 and store them and their associations on database 702. The user may also associate entities 904-906 with one or more core task entities 908 from an existing portion (e.g., entities 908-928) of database structure 900. The existing portion may be stored on database 702 or at another location/device.

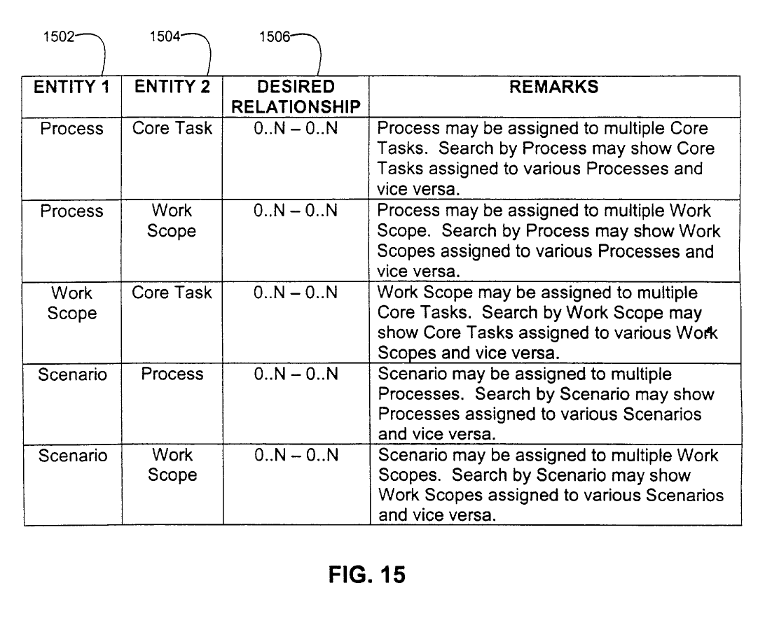

As described, a user may determine desired relationships between entities 902-908 based on the associations created using process 800. Table 1500 of FIG. 15 illustrates exemplary desired relationships between entities 902-908. As shown, multiple entities may be associated with each other. For example, a desired relationship 1506 of “0 . . . N-0 . . . N” may indicate zero or more entities of a first type of entity (e.g., 1502) that are associated with zero or more entities of a second type of entity (e.g., 1504).

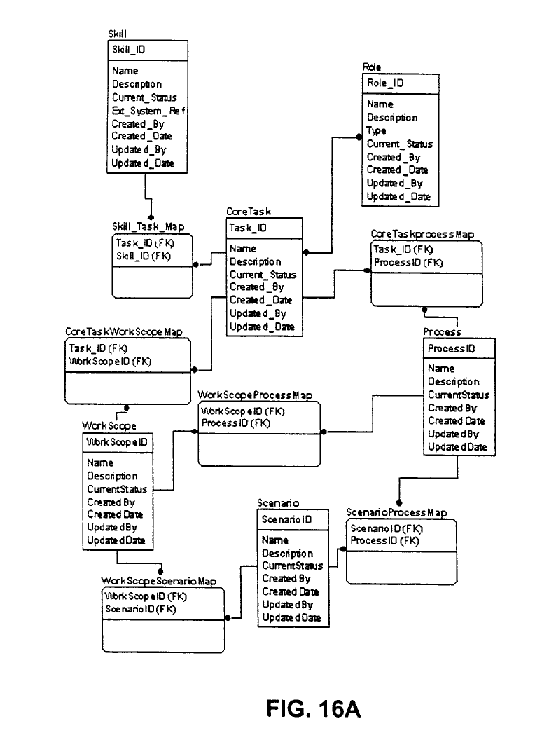

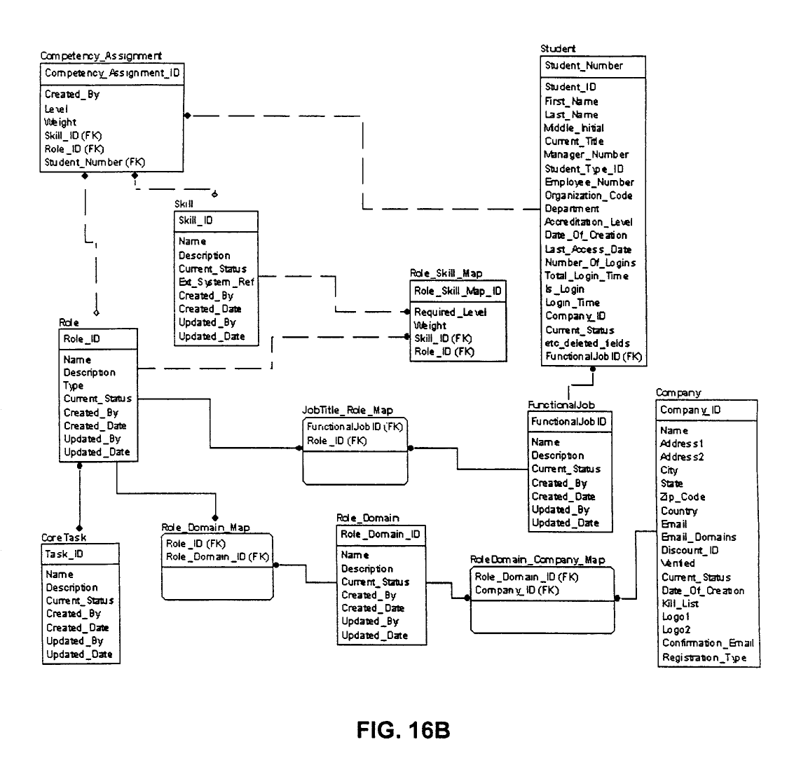

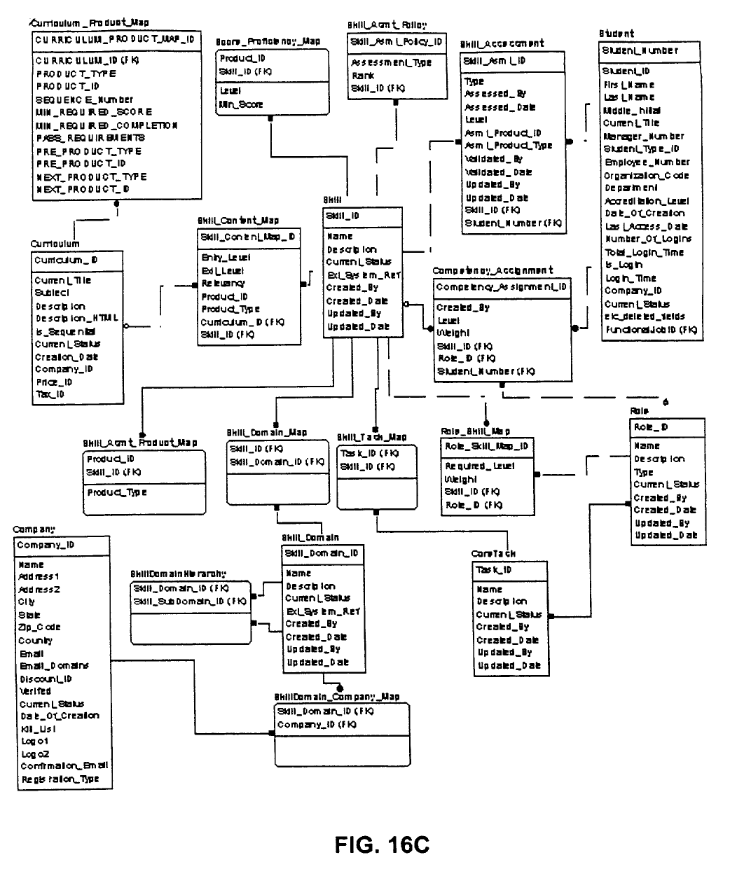

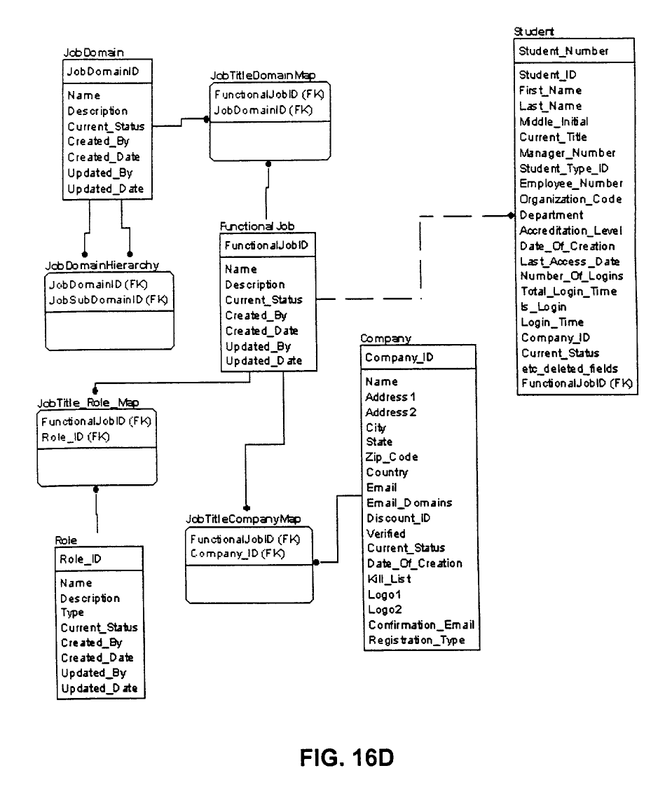

Referring to FIG. 9, in addition to the associations between scenario, process, work scope, and core task entities 902-908, zero or more core task entities 908 may be associated with zero or more role entities 916 and zero or more skill entities 910 in the existing portion. Further, the existing portion may include zero or more product entities 912, curriculum entities 914, student entities 918, job entities 920, job domain entities 922, role domain entities 924, company entities, or skill domain entities 928. The existing portion may also include additional or fewer entities consistent and compatible with features and principles of the present invention. FIGS. 16A-16D illustrate exemplary attributes of entities 902-928 in one embodiment of the present invention.

Product entity 912 (FIG. 9) may correspond to a learning product or an assessing product. A learning product may include a web-based educational course conducted over the Internet, an instructor-led training course, mentoring, etc. An assessing product may include a test or some other form of evaluation to determine the result of a student's training using a learning product.

Curriculum entity 914 may correspond to a learning path that prescribes a sequence of training events required to provide an appropriate level of knowledge and skills needed in order to perform a given task or role. Role entity 916 may correspond to a role that may be defined as described above and illustrated in FIGS. 1-6.

Student entity 918 may correspond to a student, such as an individual receiving training or an educational experience. A student may be a target student or an assessed student. A target student may be an individual that is “targeted” (i.e., identified) to receive training or an educational experience. If the training or educational experience includes an “assessment” (i.e., evaluation) of the student, then the student may be an “assessed” student.

Job entity 920 may correspond to a functional job that is the employed position of an individual within an organization. An individual may have one job with a variety of associated roles. By way of a nonlimiting example, an individual with a functional job of a technician may have to fulfill multiples roles (e.g., customer support administrator, technical support level 3, and technical support level 2).

Job domain entity 922 may correspond to a set of functional jobs (i.e., a job domain) that group related functional jobs into one or more categories. By way of a nonlimiting example, a job domain of technical support personnel may include technician, network administrator, or system administrator tasks.

Role domain entity 924 may correspond to a set of roles (i.e., a role domain) that group related roles into one or more categories. For example, a domain of maintenance roles may include sales representative, executive sponsor, customer support lead, customer system administrator, legal, finance, or technical support (levels 1 to 3) roles. Levels 1 to 3 in technical support roles may indicate roles with increasing levels of technical support responsibilities.

Company entity 926 may correspond to a company or organization that includes a variety of personnel-related factors (e.g., job domains, jobs, role domains, roles, skill domains, skills, etc.). Each company or organization may have its own set of personnel-related factors that help define a human part of the company's assets. The “human” asset may include the experience, knowledge, or skills of some or all personnel in the company.

Skill domain entity 928 may correspond to a set of skills (i.e., a skill domain that group skills into one or more categories. By way of a nonlimiting example, a skill domain of network engineering skills may include system design process, system engineering process, system integration process, standards setting process, documentation process, design evaluation, routing, sub-netting, switching, etc..

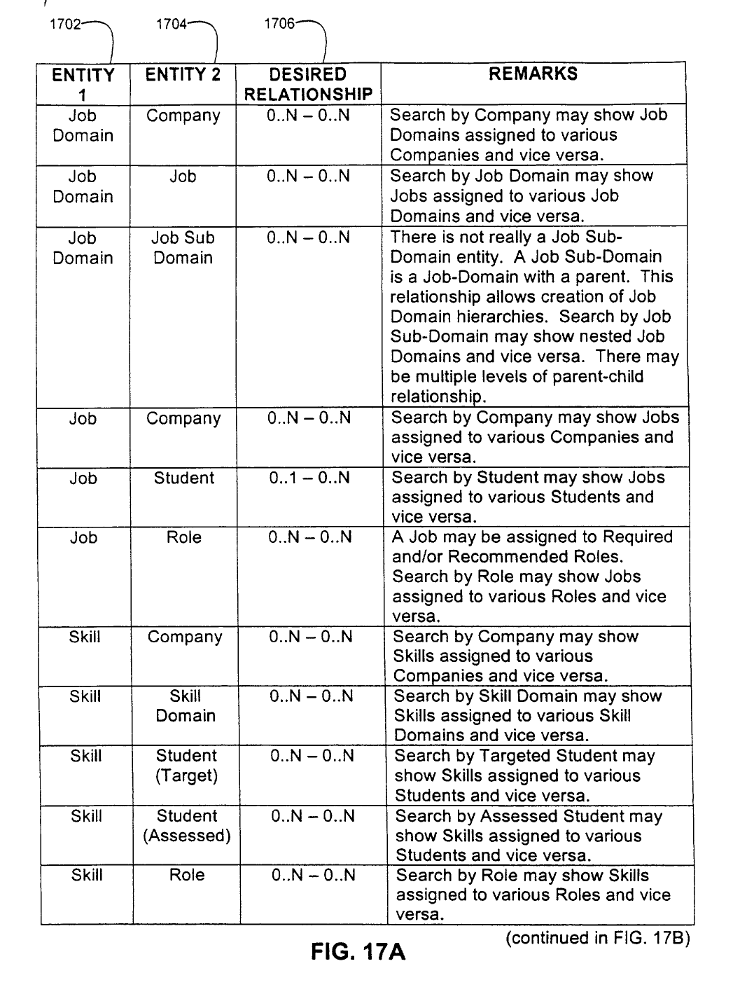

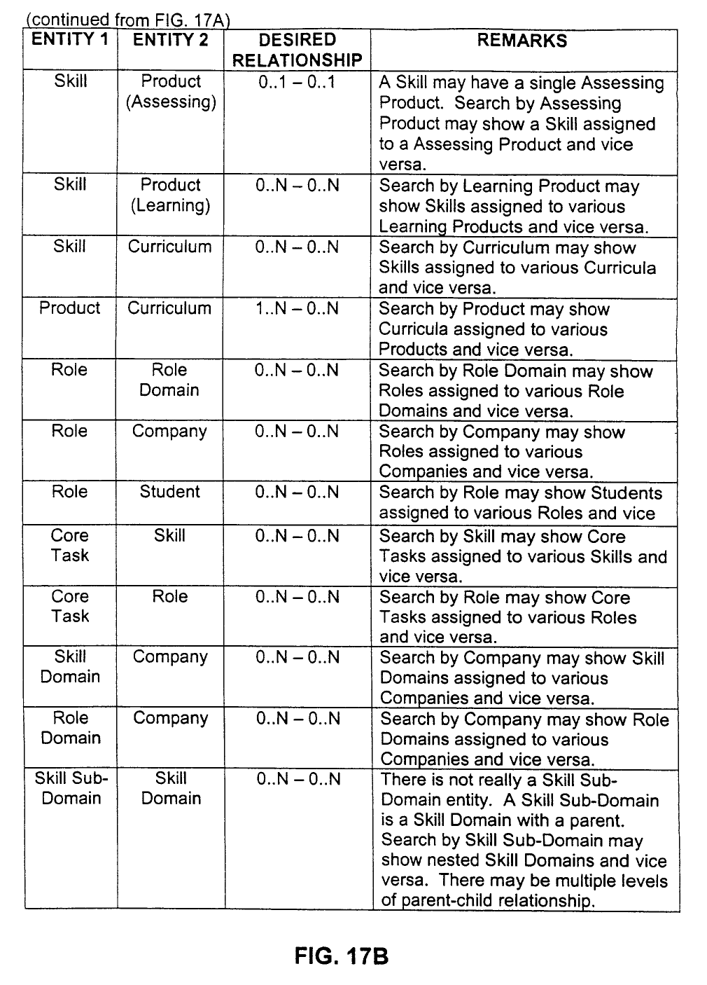

FIGS. 17A-17B illustrate exemplary desired relationships between entities in the existing portion (i.e., entities 908-928) of database structure 900. An entity may contain links or pointers (i.e., associations) to another entity that represent a relationship between the two entities. The associations may be stored with the existing portion in memory, database 702, or any other storage device. A desired relationship 1706 of “0 . . . 1-0 . . . N” may indicate zero or one entity of a first type 1702 that is associated with zero or more entities of a second type 1704, and vice versa. A desired relationship of “0 . . . 1-0 . . . 1” may indicate zero or one entity of first type 1702 that is associated with zero or one entity of second type 1704. A desired relationship of “1 . . . N-0 . . . N” may indicate one or more entities of first type 1702 that are associated with zero or more entities of second type 1704, and vice versa. Alternative, fewer, or additional desired relationships, consistent with features and principles of the present invention, may also be used without departing from the scope of the present invention.

According to features and principles of the present invention, a user, program, etc may search the associated entities to locate a given entity or information reflected by the given entity. For example, a user may enter search criteria through I/O interface 706 (FIG. 7) using a Structured Query Language (SQL), a Java applet, a relational database management system (RDBMS), a spreadsheet, or any other mechanism known in the art and compatible with certain features of the present invention. The search criteria may include one or more entities or attribute(s) of the entities. Using the search criteria, processor 704 may perform a search process that searches the stored entities and associations on database 702 to find entities that meet the search criteria and present search results to the user via I/O interface 706. For example, the user may request a search for all skills associated with addressing a critical event in a given scenario. If the scenario corresponds to a scenario entity in database structure 900 (stored on database 706), processor 704 may process the request and find all skill entities associated with the scenario entity from database structure 900. I/O interface 706 may then present, to the user, search results that include skills corresponding to the skill entities found in the search.

According to features and principles consistent with the present invention, search results may include scenario entities 902 corresponding to respective scenarios. The corresponding scenarios may be presented to teach an individual how to appropriately handle the scenarios and/or critical events included in the scenarios. Alternatively, the scenarios may allow a user to determine which individuals with the appropriate skills should handle a particular scenario based on roles, skills, etc. of individuals that can deal with the scenario.

As described above, system 700 (FIG. 7) may be used to implement process 800 (FIG. 8) to generate database structure 900 (FIG. 9). However, as one of ordinary skill in the art can appreciate, other systems or configuration of systems may be used to implement features and principles of the present invention. Further, although process 800 may include steps 802-814 as described above, as well as additional steps, one or more of steps 802-814 may be removed or reordered, without departing from the scope of certain features and principles related to the present invention. For example, the steps may be implemented and performed in any order to generate database structure 900. Additionally, a database consistent with features and principles of the present invention may contain more or fewer entities/associations, as described herein, while still being consistent with features and principles of the present invention.

In another embodiment consistent with features and principles of the present invention, the solution development and training facilitation features of the present invention may be performed automatically. For example, a knowledge base equivalent to database structure 900 may be formed. Artificial intelligence techniques (e.g., neural networks, fuzzy logic, soft computing, etc.) may then process the knowledge base to search for skills, individuals (i.e., students), or scenarios that may facilitate training or solution development and implementation. The artificial intelligence techniques may also create or update the knowledge base or database structure 900 without user intervention.

In the foregoing description, various features are grouped together in various embodiments for purposes of streamlining the disclosure. This method of disclosure is not to be interpreted as reflecting an intention that the claimed invention requires more features than are expressly recited in each claim. Rather, as the following claims reflect, inventive aspects may lie in less than all features of a single foregoing disclosed embodiment. Thus, the following claims are hereby incorporated into this description, with each claim standing on its own as a separate embodiment of the invention. Furthermore, embodiments of the present invention may be implemented by computer programs that may be stored on computer-readable media.

As used herein, the words “may” and “may be” are to be interpreted in an open-ended, non-restrictive manner. Further, the word “or” is to be interpreted in the conjunctive and the disjunctive.

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A database for facilitating solution development, comprising:
a scenario entity associated with at least one critical event;
at least one of a work scope entity and a process entity associated with the scenario entity; and
a core task entity associated with the at least one of the work scope entity and the process entity,
wherein the core task entity corresponds to at least one core task that facilitates solution development for the at least one critical event.

2. The database of claim 1, further comprising:
a role entity associated with the core task entity; and
a skill entity associated with the core task entity.

3. The database of claim 1, wherein the entities include at least one attribute.

4. The database of claim 3, wherein the at least one attribute includes at least one of an identification (ID) attribute, a name attribute, a description attribute, a current status attribute, a created by attribute, a created date attribute, and an updated date attribute.

5. The database of claim 4, wherein any one of the entities is searched in the database using at least one of the attributes.

6. The database of claim 1, wherein any one of the entities is searched for in the database using at least one associated entity.

7. The database of claim 1, wherein the at least one critical event is an opportunity that has a potential impact on a service requirement of a service contract.

8. The database of claim 1, wherein the at least one critical event is associated with at least one of a skill-related learning need and training for an individual.

9. The database of claim 1, wherein the work scope entity includes work from at least one of a core work type, a support work type, and a boundary work type.

10. The database of claim 1, wherein the at least one critical event is identified using role analysis.

11. The database of claim 10, wherein the role analysis comprises:
reviewing documents related to roles of an organization;
interviewing subject matter experts of the organization to obtain information related to the roles in the organization, wherein the information identifies the at least one critical event and specifies which roles can address the at least one critical event; and
creating one or more role analysis profiles based on the reviewed documents and interview information.

12. The database of claim 11, wherein the role analysis further comprises:
validating the created role analysis profiles; and
creating final role analysis profiles based on the validation.

13. A method for facilitating solution development, comprising:
identifying at least one critical event;
associating the at least one critical event with a scenario;
associating the scenario with at least one of a process and a work scope; and
associating the at least one of the process and the work scope with a core task that facilitates solution development for the at least one critical event.

14. The method of claim 13, further comprising:
associating the core task with a role; and
associating the core task with a skill.

15. The method of claim 13, wherein at least one of the scenario, the process, the work scope, and the core task includes at least one of an identification (ID) attribute, a name attribute, a description attribute, a current status attribute, a created by attribute, a created date attribute, and an updated date attribute.

16. The method of claim 15, further comprising:
locating the at least one of the scenario, the process, the work scope, and the core task using at least one of the attributes.

17. The method of claim 13, further comprising:
locating the at least one of the scenario, the process, the work scope, and the core task using at least one of the scenario, the process, the work scope, and the core task.

18. The method of claim 13, wherein the critical event is an opportunity that has a potential impact on a service requirement of a service contract.

19. The method of claim 13, further comprising associating the critical event with at least one of a skill-related learning need and training.

20. The method of claim 13, wherein the work scope includes work from at least one of a core work type, a support work type, and a boundary work type.

21. The method of claim 13, further comprising identifying the at least one critical event using role analysis.

22. The method of claim 21, wherein the role analysis comprises:
determining categories of roles of an organization;
reviewing documents related to the roles of the organization;
interviewing subject matter experts of the organization to obtain information related to the roles in the organization, wherein the information identifies the at least one critical event and specifies which roles can address the at least one critical event; and
creating one or more role analysis profiles based on the reviewed documents and interview information.

23. The method of claim 22, wherein the role analysis further comprises:
validating the created role analysis profiles; and
creating final role analysis profiles based on the validation.

24. The method of claim 13, further comprising presenting the scenario to an individual for training.

25. A scenario-based system for facilitating training, comprising:
a scenario entity associated with at least one critical event; at least one of a work scope entity and a process entity associated with the scenario entity;
a core task entity associated with the at least one of the work scope entity and the process entity;
a skill entity associated with the core task entity; and
a student entity associated with the skill entity,
wherein the skill entity is associated with at least one skill for facilitating solution development of the at least one critical event, and wherein the student entity is associated with a student that is at least one of targeted and assessed to be trained in the skill.

26. The system of claim 25, wherein at least one part of at least one of the entities is identified using role analysis.

27. The system of claim 26, wherein the role analysis comprises:
determining categories of roles of an organization;
reviewing documents related to the roles of the organization;
interviewing subject matter experts of the organization to obtain information related to the roles in the organization, wherein the information identifies the at least one part of at least one of the entities; and
creating one or more role analysis profiles based on the reviewed documents and interview information.

28. The system of claim 27, wherein the role analysis further comprises:
validating the created role analysis profiles; and
creating final role analysis profiles based on the validation.

29. A method for facilitating training, comprising:
determining whether a student requires training in a skill;
associating the skill to a core task;
associating the core task to at least one of a process and a work scope;
associating the at least one of the process and the work scope to a scenario; and
associating the scenario to at least one critical event,
wherein the skill addresses, at least in part, the critical event.

30. The method of claim 29, wherein at least one part of at least one of the student, the core task, the process, the work scope, and the scenario is identified using role analysis.

31. The method of claim 30, wherein the role analysis comprises:
determining categories of roles of an organization;
reviewing documents related to the roles of the organization;
interviewing subject matter experts of the organization to obtain information related to the roles in the organization, wherein the information identifies at least one part of at least one of the student, the core task, the process, the work scope, and the scenario; and
creating one or more role analysis profiles based on the reviewed documents and interview information.

32. The method of claim 31, wherein the role analysis further comprises:
validating the created role analysis profiles; and
creating final role analysis profiles based on the validation.

33. A system, comprising:
a memory device including:
a scenario component that describes at least one event; and
one or more other components associated with the scenario component; and
a processor for executing a program that uses the components to determine a solution to a problem corresponding to the at least one event.

34. A method for providing information based on an event, comprising:
creating a data structure including a plurality of entities inter-related by at least one respective attribute; and
providing, based on the entity relationships, information reflecting a solution to an event included in a scenario.

35. The method of claim 30, wherein the entities include at least one of a scenario entity, a work scope entity, a process entity, a core task entity, a skill entity, a product entity, a curriculum entity, a student entity, a job entity, a job domain entity, a role domain entity, a company entity, and a skill domain entity.

36. The method of claim 30, wherein providing information comprises:
searching the data structure for a scenario entity that corresponds to another scenario that is substantially similar to the first scenario;
locating at least one of a work scope entity and a process entity associated with the scenario entity, wherein the at least one of the work scope entity and the process entity includes information reflecting a solution to an event in the other scenario; and
providing information reflecting the solution to the event in the first scenario, wherein the solution to the event in the first scenario corresponds to the solution to the event in the other scenario.

37. A method for evaluating a scenario, comprising:
accessing a data structure including a set of entities that represent attributes associated with an organization's ability to perform at least one task;
determining a relationship between one or more entities in the set of entities based on a work scenario; and
identifying an individual with a first level of skill that is sufficient to at least one of correct and attempt to correct a problem associated with the work scenario.

38. The method of claim 33, wherein determining the relationship comprises:
searching one or more attributes associated with each entity in the set to determine a relationship between a respective entity and the work scenario.

39. The method of claim 33, further comprising:
identifying, based on the determined relationship, at least one individual that requires training, wherein the training would raise the at least one individual's skill level to the first level.

40. The method of claim 33, wherein the entities include at least one of a scenario entity, a work scope entity, a process entity, a core task entity, a skill entity, a product entity, a curriculum entity, a student entity, a job entity, a job domain entity, a role domain entity, a company entity, and a skill domain entity.

41. A system for providing information associated with a work scenario, comprising:
a memory device including:
a data structure that includes a set of entities, wherein the entities are inter-related based on a respective association with a work scenario,
a program for accessing the data structure and determining a subset of entities, wherein the subset of entities are related in a manner that facilitates management of an event of the work scenario; and
a processor for executing the program.
